(19) United States
(12) Patent Application Publication
(10) Pub. No.: US 2004/0262241 A1
(43) Pub. Date: Dec. 30, 2004

(54) High efficiency decontamination method and apparatus for the treatment of indoor air

(76) Inventor: Jeffrey Socha, Berlin, MA (US)

Correspondence Address: Kevin S. Lemack, Nields & Lemack, Suite 7, 176 E. Main Street, Westboro, MA, 01581, US

(21) Appl. No.: 10/607,939

(22) Filed: Jun. 27, 2003

(51) Int. Cl. B01J 19/08

(52) U.S. Cl. 210/760; 422/186.07; 422/4

(57) ABSTRACT

A method and apparatus for the sterilization of air by destroying viral and/or biological contaminants is disclosed. Large concentrations of ozone mix with ambient air in a mixing chamber with a residence time long enough to destroy the contaminants. An ozone concentration high enough to efficiently destroy said contaminants, is inherently too high to be inhaled by people. This ozone laden, decontaminated air is then scrubbed or catalyzed to reduce the ozone concentration, below the current OSHA limits of 0.1 ppm for an 8-hour continuous exposure. The “conditioned” air can then be delivered to an indoor space. Incorporated in this decontamination apparatus is an ozone interlock system, which ensures that residual ozone does not enter the indoor air space.

### BACKGROUND OF THE INVENTION

Traditionally, the most common way to reduce or eliminate contaminants from air, specifically biological and viral contaminants, is to filter them. Particle arrest filters and/or HEPA (High Efficiency Particle Arrest) filters simply trap contaminants, not allowing particles of a certain size to pass through the filter media.

Current filter efficiency is a function of the media type, thickness, geometry, and electro-static attraction just to name a few characteristics of interest. In an effort to increase decontamination efficiency, traditional filters will develop a larger pressure drop across them due to the media density and thickness. Viral contaminants are microscopic, along the order of 0.1 microns (Ref. Modern Biology, J. Otto, Albert Towle) . A filter media appropriate to capture such minuscule particles would have a very high pressure drop across it. This, in turn, requires larger, more powerful fans to move a smaller volume of air through the filters. Also, the restriction of the filter media (pressure drop) is exacerbated as the filter media becomes “loaded” with contaminants that act like plugs, which get wedged into the pores. It is not practical or perhaps even possible to filter hundreds or thousands of cfm of air, required for many applications, down to the sub micron level. Another potential problem with filtering contaminants is if the filter media is torn or there is a poor seal between the filter and the filter housing, untreated air can bypass filtration.

Traditional filters need to be replaced occasionally. When contaminant-laden filters are disrupted, upon replacement for example, some contaminants will become dislodged. Changing a filter that has accumulated biological or viral contaminants may elicit unnecessary human exposure for the one who has to replace it. This may require the use of containment suits, which themselves become toxic once they come into contact with the accumulated toxins on or near the dirty filters. Depending on the accumulation of specific contaminants in the filter media, proper disposal may include treating spent filters as toxic waste.

Ozone is highly reactive—an excellent oxidizer—its ability to destroy contaminants is well known. Due to the reactive nature of ozone, it is indiscriminate of “good” and “bad” organics (biohazardous pollutants or humans). In other words, ozone can destroy biological contaminants but it can also trigger asthma or cause lung damage. Currently, there are several “air purification” products in the marketplace, which add ozone to indoor air. These products do not reduce viral or bacterial contaminants efficiently, due to the low concentration of ozone that they produce which is necessary to comply with OSHA limits. Several examples of these products are found in U.S. Pat. Nos. 5,501,844 and 5,681,533. The U.S. Environmental Protection Agency (EPA) states “Available scientific evidence shows that at concentrations that do not exceed public health standards, ozone has little potential to remove indoor air contaminants” (Ref. “Ozone Generators That are Sold as Air Cleaners: An Assessment of Effectiveness and Health Consequences”). Simply stated, “air purifiers” which add an acceptable, breathable, concentration of ozone into the air are simply ineffective to reducing biologic or viral contaminates.

Some equipment utilizes high concentrations of ozone to improve indoor air quality, such as those found in U.S. Pat. Nos. 5,186,903, 5,221,520, and 5,73,730, for example. The primary function of ozone in these specific cases is to break down (oxidize) ammonia and/or heavy hydrocarbons. This aforementioned equipment has no means to efficiently destroy bio-contaminates for the follow reasons: there is no regulation of the concentration of ozone, there is no provision for adequate mixing such as a mixing chamber, the residence time is too short and the achievable ozone concentrations are too low, and they do not contain safety interlock equipment in the event of ozone entering the indoor air space, as ozone is toxic. These previously excluded components are necessary to ensure the proper mixing and residence time of ozone with the contaminants, as well as to provide a controllable ozone concentration which are required for the high destruction efficiency of bio-contaminants.

Unless otherwise stated, “contaminants” as sited in this disclosure implies biological, fungal, viral, bacterial, or any other undesirable particle as it relates to human or animal respiratory function, or scientific research.

It seems appropriate to destroy viral and biological particles instead of simply capturing them. Ozone is very reactive, and by definition makes it an excellent candidate for organic contaminant destruction (Ref. “Bactericidal Effects of High Airborn Ozone concentrations on Escherichia coli and Staphylococcus aureus”, W. J. Kowalski, W. P. BahnFleth, And T. S. Whittam) and (Ref. “Possible Mechanisms of Viral Inactivation by Ozone”, Gerard V. Sunnen, M.D.). Ozone can be added to an air stream, but must not enter an area occupied by humans or animals if the concentration exceeds 0.1 ppm for an 8-hour exposure (Ref. OSHA Air Contaminants Standard, 29 CFR 1910.1000). As stated earlier, an ozone concentration at a level low enough to comply with the OSHA limits is simply not enough to efficiently destroy viral and bacterial contaminants

The object of the present invention is to destroy viral and/or biological contamination, rather than “capture” it as traditional filters or HEPA filters do. A major advantage of this approach is the low pressure drop across this apparatus as compared to traditional particle arrest filters and/or HEPA filters. Also, filters are especially poor at capturing viral contaminates due to their extremely small size. This invention does not cause contaminates to build up since they are destroyed and not collected. Because of this elimination of contaminant build-up, there is also the elimination of disposing of “soiled” filters. In the case of a bio-terrorism attack for example, large accumulations of bio-toxins in traditional filters, in addition to being ineffective, would cause the dirty filters to become toxic waste.

The need for a highly efficient decontamination apparatus is important in an age where bio-terrorism is an increasing concern. This invention is ideal for treating indoor air at locations where bio-terrorism is a possibility. Other applications may include the treatment of air that is entering a laboratory engaged in medical, genetic, pharmaceutical or biological research. Any scientific research relies on the premise that there is no introduction of an unknown contaminant, specifically organic in nature. This apparatus can also be used to treat air exhausted from a laboratory, which may be using, developing, manufacturing, or testing bio-toxins.

### SUMMARY

This invention is intended to destroy airborne viral or bacterial contaminants before they enter or return back into an indoor air space. It is not necessarily intended to remove particles, though that can be done in conjunction with traditional filters. Destroying viral/biological particles can be accomplished by taking outdoor air, indoor return air, or a combination of both, and mixing high concentrations of ozone with it. This mix of contaminated air and ozone requires a certain residence time that is long enough to render the contaminants inactive. However, an ozone concentration high enough to efficiently destroy said contaminants, is inherently too high to be inhaled by people. This requires that the ozone be destroyed after it has had sufficient time to mix with the contaminated air, but before it enters the indoor air space. Ozone can easily be converted to diatomic oxygen using a variety of catalytic materials.

The present invention allows high concentrations of ozone to destroy contaminants, which may be present in air, but safely converts the ozone into oxygen (in diatomic or atomic form) before it enters an indoor air space. Ozone can easily be converted into oxygen with the use of a proper catalyst or scrubber, for example, manganese dioxide. (Ref. “Catalytic Destruction of Ozone at Room Temperature”, N. Singh, K. S. Pisarczyk, J. J. Sigmund). This process utilizes ozone at high concentration without risk to living beings in the indoor air space. An inherent advantage in using ozone for any application is that it is produced at the point of use. If there is an ozone leak, simply stopping the flow of power to the generator will nearly instantaneously stop the production of ozone. This is in contrast to a potential leak in a bottled gas in which there is little recourse to stopping or containing it.

The disclosed apparatus contains ozone detection equipment, which is interlocked with the external ozone generator and isolating dampers. These safety provisions are essential in order to maintain a safe discharge concentration of ozone into the occupied indoor space. For example, if for some reason the catalyst, which is needed to destroy the ozone, was rendered inoperable, this apparatus will shut down the ozone generator and close the isolation dampers. This redundant, two-pronged approach can ensure the safety of the people downstream of this equipment. Since human safety is paramount, there must be a provision for the detection of ozone at levels above what is considered safe as well as an interlock to stop the flow of ozone from entering the indoor space.

This invention can decontaminate outdoor air or return indoor air. The ratio of outdoor air to return indoor air is determined by several factors such as desired decontamination efficiency, current indoor air temperature set point and outdoor air temperature, and volume of make up air which can be removed from the indoor space by other equipment (vents, fume hoods, etc.). Maintaining desirable indoor air quality, such as acceptable levels of carbon monoxide, radon, carbon dioxide, also determines the ratio of return air to outdoor air. Equipment, which controls this ratio of indoor return air to outdoor air, is conventional, typically being found as part of the HVAC equipment, which is used to heat or cool the air. This invention may be used in conjunction with such equipment.

### BRIEF DESCRIPTION OF THE DRAWINGS

FIG. 1 is a two-dimensional top view of the decontamination apparatus.

FIG. 2 is a two-dimensional top view of the mixing chamber and ozone injection manifold.

### DETAILED DESCRIPTION OF THE INVENTION

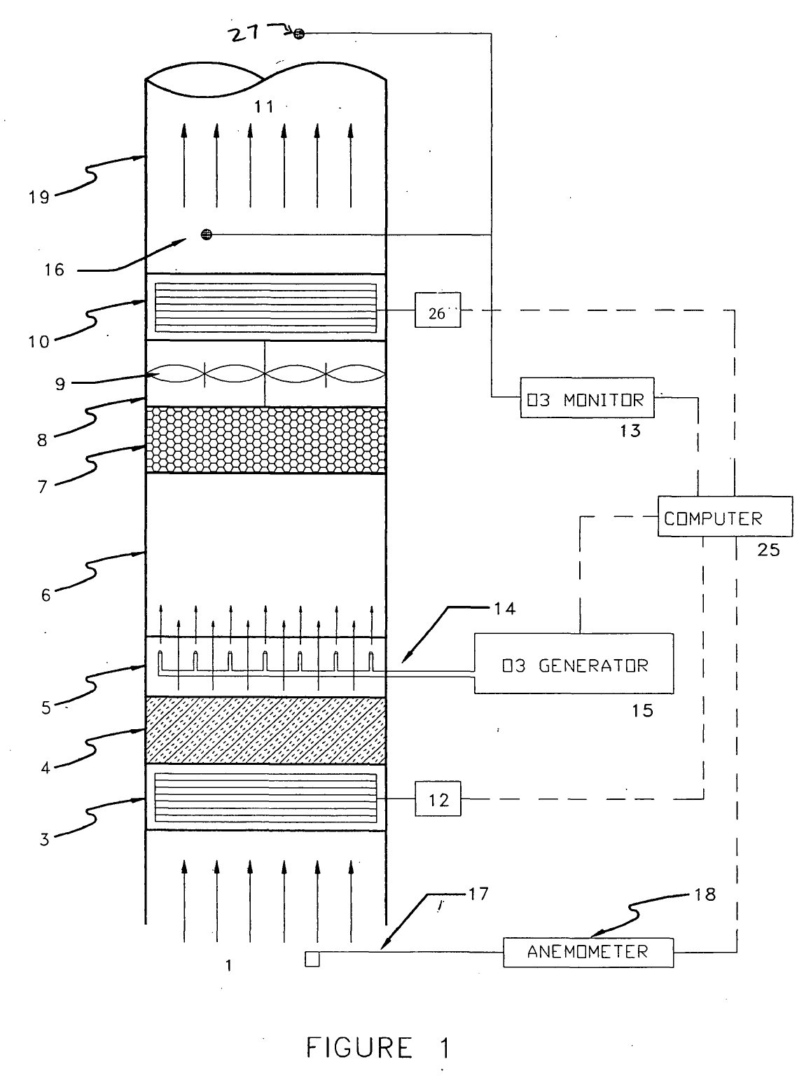

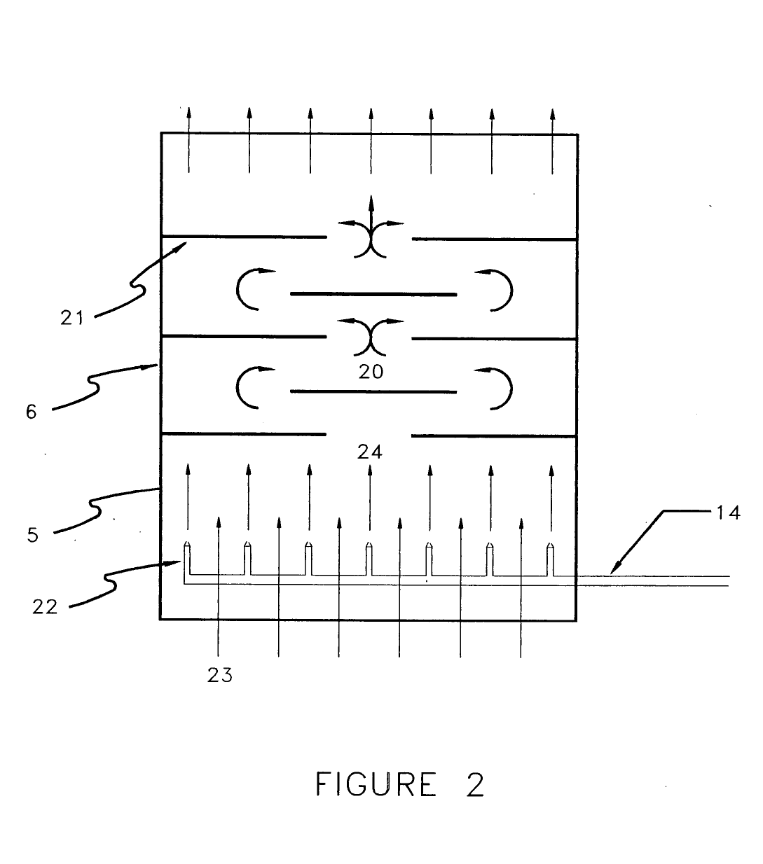

For the purposes of this description, “unit” implies the entire inventive apparatus. A preferred embodiment of this invention is represented in both FIGS. 1 and 2. In FIG. 1 (top view), contaminated inlet air 1 passes into the inlet air damper 3. The air-drawing devices 9, which can be fans or blowers, are located downstream from the inlet damper 3, and are used to create a pressure, which is negative compared to the ambient air pressure causing the inlet air 1 to be drawn into the unit. The source of the contaminated air 1 is not particularly limited; for example, it can be outdoor air, return indoor air, or a combination of both. The ratio of outdoor air to return indoor air is determined by several factors such as desired decontamination efficiency, current indoor air temperature set point and outdoor air temperature, and volume of make up air which can be removed from the indoor space by other equipment (vents, fume hoods, exhaust fans). Maintaining desirable indoor air quality, such as acceptable levels of carbon monoxide, radon, carbon dioxide, also is a factor in determining the ratio of return air to outdoor air. Equipment, which controls this ratio of indoor return air to outdoor air, is conventional and is typically part of the HVAC equipment, which is used to heat or cool the air. This invention is intended to be used in conjunction with such equipment and will function with any combination of air sources. Also, (although not shown in the figure), it is possible to have the present invention have a loop-back or recycle capability where the treated air can be directed back into the inlet for a second treatment, which would further increase the decontamination efficiency. Such recycle could take the form of an additional duct and an additional damper, which would direct the air to the indoor space or back to the inlet.

The inlet air damper 3 can be used to regulate the amount of air that enters the decontamination apparatus. For example, the amount of air throttled by damper 3 is controlled by a damper motor 12 associated with the damper 3. The required air volume is a function of the desired indoor air quality requirements stated above. Alternatively, the volume of incoming air can be controlled by using a “variable frequency drive” on the air-drawing devices 9. These devices vary the frequency from 0 to 60 Hz at a fixed voltage, which is proportional to the immediate airflow requirement. These devices are readily available and are usually used in traditional air handling units, such as commercial air conditioners.

The controlled volume of air then optionally enters into a filter 4, preferably a filter array, which optionally may include one or more HEPA filters (High Efficiency Particle Arrest). The filter 4 removes at least some of the contaminants from the inlet air 1. This array is optional and can be placed anywhere before the ozone injection chamber 5 or after the ozone catalyst section. After the contaminated air is filtered, it enters into the ozone injection chamber 5.

In addition to one or more filters, the temperature and/or humidity of the air may be controlled or modified such as by using a heating coil, cooling coil, or humidification injection section, since these items are often used to treat indoor air in regards to comfort. Humidity level plays a part in determining the efficiency of ozone to destroy bio-contaminants, thus the addition of a humidifier in the apparatus may improve the effectiveness of the present invention.

Ozone is not practical to store due to its relatively short half-life. Because of this storage limitation, ozone preferably is produced near the point of use. In accordance with one embodiment of the present invention, ozone is produced by an ozone generator 15 using ambient air or bottled feed gas. Depending on the type of ozone generator used, it may require air cooling or chilled water cooling. The ozone generator 15 preferably should be mounted externally. This allows a higher level of serviceability and replacement along with reduced cost compared to an integrated ozone generator located inside of the air stream. Details of the type of ozone generator are not specifically addressed within this disclosure as these are known in the art and the types and variety of commercial ozone generators available are more than sufficient to produce the ozone required for the decontamination unit of the present invention. Other suitable ways of producing ozone are known in the art and include electro-chemical, UV-light (Photolitic), or production by corona discharge. For the concentrations required in this application, a corona discharge ozone source is the preferred choice. A commercially available ozone generator, used in the example of the operation of this apparatus, is the Mitsubishi Electric Model OS-J. Other manufactures include Osmonics, NovaZone, and Ozomax. To produce high concentrations of ozone required for this application, cooling water or a chiller is often required to cool the ozone generator. Also, air treatment systems may be required by certain ozone generators to dry the air that will be converted into ozone. Some ozone generators require a feed gas such as oxygen, which improve the ozone generator performance. Ozone generators are a well-established and commercially available item. The type of ozone generator used for this invention is more of a logistics issue such as cost and space available. However, due to the large concentrations of ozone required at high flow rates, the preferred type of ozone generation is by corona discharge.

In order to reliably control the contamination destruction efficiency, the output of the ozone generator preferably is measured and/or monitored. The ozone concentration and flowrate into the apparatus can be measured using an ozone analyzer and a flowmeter, for example. Knowing the parameters and the flowrate of the incoming air into the apparatus, the final ozone concentration can be measured and maintained. Also, from a safety interlock standpoint, a low concentration analyzer is recommended downstream of the ozone catalyst or scrubber, although this analyzer is not essential to performing bio-decontamination. These devices are readily available and can be of the electro-chemical type or light absorption type.

FIG. 2 (top view) shows the filtered contaminated air 23 as it leaves the filter 4, entering into the ozone injection chamber 5. Contained within this chamber 5, is an array of ozone injection nozzles 22, which preferably is designed to distribute the ozone gas 24 in the chamber 5 as evenly as possible, via an ozone gas manifold 14. The manifold 14 provides communication between the nozzles 22 and the ozone source, such as ozone generator 15. The array of nozzles 22 creates a cross-sectional bank of nozzles specifically designed for maximum diffusion into the filtered contaminated air 23. The amount of nozzles should be as numerous as is practical, although those skilled in the art will appreciate that the present invention can operate with any number of nozzles, including a single nozzle. While a plurality of nozzles is the preferred embodiment, other suitable methods for injecting ozone into the inlet air are within the scope of the present invention. Preferably the ozone is piped directly into the center of the inlet airflow. Alternatively, a set of plates that are perforated to allow ozone to become defused into the air stream can be positioned in the chamber 5 or downstream thereof. For example, these plates can sit in the cross-section of the apparatus, placed before the mixing chamber, and the outlet of the ozone generator is piped to the diffusion plates. These plates also have through holes in them to allow the incoming air to travel through them with a minimum of pressure drop.

The mix of ozone and filtered contaminated air 20 enters into the mixing chamber 6 that is in fluid communication with the chamber 5. The purpose of the mixing chamber is to optimize the mixing efficiency of ozone gas 24 and filtered contaminated air 23. In order to facilitate this mixing, baffles 21 preferably are present in the mixing chamber. The baffles should be numerous enough to ensure proper mixing, but not so many as to creates a large pressure drop or flow restriction for the upstream fans or blowers 9. The baffles 21, as illustrated in FIG. 2, can be arranged in a variety of ways, and are not limited to the arrangement shown. Preferably the arrangement used creates a tortuous path for the flow of air and ozone. Baffles may also be arranged such that they create a vortex, to further optimize mixing. In addition to or in lieu of mixing baffles, an array of helical structures in the mixing chamber would create mixing vortices as a practical and efficient alternative to mixing baffles. An array of these helical mixers could be placed in a stack to fill a cross section of the apparatus. However the mixing is accomplished, the length of the mixing chamber is crucial in determining the decontamination efficiency, as this relates directly to the residence time of the ozone with the contaminated air.

The volume of the mixing chamber preferably is sized in accordance with the volume of air to be conditioned. Other sizing criteria include the flow and concentration of the ozone gas injected into the contaminated air. Efficiency of the biological contaminant destruction is a function of residence time with ozone, mixing efficiency, concentration of the ozone injected, gas volumes of ozone and contaminated air, humidity, and ambient temperature.

A major contributor to the efficiency of decontaminating air using ozone is ensuring that the bacteria or viral contaminants are not clumped together. “Clumping” can be reduced by adding sonic waves (sound waves) into the air stream. This will cause clumps of particles to break up into smaller particles, thus allowing the ozone to more efficiently attack the organic particles. A mechanism for producing sonic waves, such as an oscillating diaphragm constructed of stainless steel for example, could optionally be placed in the sides of the mixing chamber to create repetitive shock waves to the air mix and reduce the amount of clumping. Sonication also enhances mixing of the ozone with the air.

After the mix of ozone and contaminated air 20 has had sufficient time to ensure an acceptable level of decontamination efficiency, the mix enters into the ozone catalyst section 7 (FIG. 1). At this location, ozone, tri-atomic oxygen, is reduced to a mixture of di-atomic and atomic oxygen. Tri-atomic oxygen (ozone) is toxic in high concentrations (>0.3 ppm). Di-atomic and atomic oxygen are both acceptable and required for human health. The size and geometry of the ozone catalyst chamber 7 is governed by at least three criteria listed below. First, the surface area should be sufficient so that it can convert the upstream ozone concentration to below the OSHA limit of 0.1 ppm (more preferably below 0.02 ppm) . Second, the catalyst chamber should be as non-restrictive as possible so as to minimize pressure drop. Third, the catalyst material, such as manganese dioxide, should mix sufficiently enough with the ozone-laden air as to ensure acceptable ozone discharge concentrations.

Destroying the ozone after the ozone has destroyed the contaminants can be carried out in a number of ways such as catalytically and/or thermally. Choices for catalytic destruction of ozone are the most practical and there are several commercially available products that are effective. The following is a list of suitable ozone catalysts:

1. Carulite Composition; Manganese Dioxide, Copper Oxide, Aluminum Oxide

2. Hopcalite or Moleculite Composition; Manganese Dioxide, Copper Oxide, Lithium Hydroxide

3. Zeolite Composition; Sodium Aluminosilicate

4. Activated Carbon Composition: Carbon (this works by absorbing the ozone, which is different than catalytic destruction of ozone)

5. KI or Potassium Iodide (this works by absorbing the ozone, which is different than catalytic destruction of ozone)

6. Silver, Palladium, or Platinum

The above materials can be obtained and used in a granular form, extruded form, or be sprayed onto a mesh, screen, or honeycomb structure, (which offers a high surface area with a minimum of pressure drop), for example. Japanese Patent 1989-115352 mentions a honeycomb of manganese containing catalyst and was referenced in U.S. Pat. No. 5,681,533, the disclosures of which are hereby incoroporated by reference. There are a myriad of metals and metal oxides and combinations of metal oxides that catalyze ozone with various efficiencies. A filter may be placed downstream of these catalyst beds to capture any catalyst particles that may enter the air stream.

Ozone can also be destroyed using extreme heat. The half-life of ozone is a function of temperature. By heating ozone to 300° C., for example, the half-life is a fraction of a second. Thermal ozone destruction is particularly beneficial where the air stream is saturated or condensing with moisture.

Referring back to FIG. 1, the treated air 11 (contamination reduced and ozone reduced) then enters into the fan chamber 8. One or several air-drawing devices 9, such as fans or blowers, force the air past the discharge isolation dampers 10, into the discharge duct 19. The illustrated location of the air-drawing device within the apparatus is not intended to be limiting. In the preferred embodiment, the air-drawing devices are placed in an area where the concentration of ozone is low, as ozone is extremely corrosive. Most preferably, the air-drawing devices are placed close to the outlet so as to create a negative air pressure environment within the apparatus, minimizing the extent of ozone leaking from the apparatus in the event of a leak.

The discharge damper is controlled by a discharge damper motor 26 which is normally open unless there is a call for the damper to close in the event of a malfunction, as discussed in greater detail below. The treated air 11 can then be directed as required by the specific application.

Preferably the air decontaminating apparatus of the present invention has a safety interlock system. This interlocking is carried out by a central computer 25. This computer can be a special purpose microcontroller, a more standard personal computer, or any type of processing unit capable of receiving a plurality of inputs and generating a plurality of outputs. Inputs to the computer include data from the ozone monitor(s), the ozone generator 15, the anemometer 18 and any other input deemed useful or necessary for a specific application. Based upon analysis of data received, the computer 25 can control one or more of following; the ozone generator 15, the inlet damper control motor 12, the discharge damper motor 26, and any other function deemed useful or necessary buy a specific application.

One or more ozone sample ports preferably are installed in the unit, preferably at least in the air discharge duct 16 and outside the unit 27. These ozone sample ports are connected to one or more ozone monitors 13, which measure the amount of ozone at the sample port and relay this information to the computer 25. If the concentration of ozone in the treated air 11 exceeds a predetermined amount, such as an amount deemed unhealthy (nominally, concentrations greater than 0.1 ppm), the ozone monitor 13 will shut down the ozone generator 15 via the computer 25. The computer 25 will also signal to close both the inlet air damper 3 and the discharge isolation damper 10 via the two motors 12 and 26, respectively.

In addition, preferably sample ports 16 and 27 draw an air sample from the discharge duct and the indoor air space, respectively, to measure the ozone concentration in “real time”. While only two sample ports are illustrated in this figure, fewer or additional air samples at predetermined locations can be monitored by either a multi-channel ozone analyzer or multiplex analyzers. Other sample ports may be added in other locations as deemed useful or necessary.

In order to maintain a consistent level of decontamination, an anemometer 18 and associated probe 17 preferably monitor the air velocity at the inlet of the unit. Knowing the cross-sectional area of the air inlet and the linear velocity of the air, it is possible to determine the air volume entering the unit. The anemometer can be placed anywhere, preferably out of contact with the ozone-laden air, most preferably at the inlet of the unit. Depending on the air volume required by the downstream indoor air space, there needs to be a known, corresponding concentration and flow-rate of ozone infused into the volume of air to be treated. The anemometer 18 information is continually or continuously sent to the computer 25, which calculates a corresponding ozone concentration and delivery flow rate for the system. This information is then used to control the output of the ozone generator. In this manner, the apparatus is able to maintain a consistent level of decontamination by continually or continuously adjusting the amount of ozone infused in response to varying inlet air volume. This is a dynamic system. For example, if 5,000 cfm is required of the apparatus it will adjust the ozone delivered in order to maintain a predetermined mixing ratio. If 2 hours later, 1,000 cfm is required, the ozone delivered will again be adjusted to meet a minimum mix ratio.

Since ozone is such an excellent oxidizer, those parts of the apparatus that are exposed to ozone should preferably be constructed of an oxidation resistant material such as stainless steel.

This air decontamination unit can be scaled to any size. For example, it may be small enough to suit the need of an individual or large enough to service an entire building. Alternatively, more than one decontamination unit can be used in series or in parallel to treat contaminated air.

The following is an example of this apparatus, which may be typical of the ozone concentrations, ozone/air mixture residence time, and overall scale. This serves only as an example and other implementations are possible. The preferred embodiment is rectangular in cross section with dimensions such as 10 ft by 10 ft square. The mixing chamber is 15 feet in length. The fan(s) are sized for an air intake rate of 5,000 CFM (cubic feet per minute). The linear velocity of the air, which is required later, is the volumetric flow-rate divided by the cross-sectional area given as:

$${v}_{linear} = \frac{Vol}{t} \times \frac{1}{{Area}_{ccs}} or {v}_{linear} = \frac{5 , 000 {ft}^{3}}{1 min} \times \frac{1}{100 {ft}^{2}} = 50 \frac{ft}{min}$$

In practice the inlet air velocity can easily be measured using an anemometer located at the inlet of the apparatus. Ozone is injected into the incoming air-stream using a manifold with multiple injection ports to optimize gas mixing. The decontamination efficiency of this apparatus is a function of ozone concentration and residence or mixing time of the ozone with the incoming air. Once linear velocity is known, the residence time of the ozone with the incoming air can be calculated by dividing the effective length of the mixing chamber by the linear velocity, given as:

$${t}_{residence} = \frac{{l}_{chamber}}{{v}_{linear}} or {t}_{residence} = \frac{15 ft}{50 \frac{ft}{min}} = 0.3 min = 18 sec$$

The effective ozone concentration in the mixing chamber is a function of the air flowrate into the system, 5,000 cfm in this example, and the ozone flowrate and concentration which is injected into the inlet air. Since commercial and industrial ozone generators are typically specified by their output in units of gr/hr of ozone, the concentration of the ozone mix is calculated by the ratio of gr/hr of air entering the system and the gr/hr of ozone injected into this air. Using a Mitsubishi ozone generator, Model OS-J, in this example, 3 kg/hr of ozone is generated and combined with 10,852 kg/hr of untreated air. This mass ratio yields an ozone concentration of 276 ppm (wt).

$${Massrate}_{air} = ( \frac{Vol}{t} \times t ) x {ρ}_{air} or$$

$${Massrate}_{air} = ( \frac{140 {m}^{3}}{min} \times \frac{60 min}{1 hr} ) x 1.292 \frac{kg}{{m}^{3}} = 10 , 852 \frac{kg}{hr}$$

$$Where 1 {ft}^{3} = 0.028 {m}^{3} hence 5 , 000 {ft}^{3} = 140 {m}^{3}$$

$${ρ}_{air @ 20 ° C .} = 1.292 \frac{kg}{{m}^{3}}$$

Research performed by The Pennsylvania State University yielded the following survival fractions for Escherichia coli and Staphylococcus aureus respectively;

E.coli S=0.9976e^{-25t}+0.0024e^{-0.0073t}

S.aureus S=0.9971e^{-0.50t}+0.0029e^{-0.0086t}

These bactericidal decay equations are based on an ozone concentration of 300 ppm. Combining these equations, with the residence time of 18 seconds, derived above yields a survival fraction of 0.013, or 1.3% for E. coli and 0.0026, or 0.26% for S. aureus. These survival rates could be expected in the case of a “slow” decay rate, which occurs when bacteria “clumps” together. If the decay reaction is considered “rapid”, where clumping of bacteria is minimal, the survival fractions are 0.0087, or 0.87% for E. coli and 0.00002, or 0.002% for S. aureus.

What is claimed:

1. Apparatus for treating contaminants in a fluid, comprising a housing having an inlet for said contaminated fluid, an ozone chamber in fluid communication with said inlet and in which said contaminated fluid is mixed with ozone, an ozone destruction chamber in fluid communication with said ozone chamber and in which the concentration of ozone in said mix is reduced, and an outlet for the flow of decontaminated fluid.

2. The apparatus of claim 1, wherein said ozone destruction chamber comprises a catalyst effective for converting ozone to diatomic and atomic oxygen.

3. The apparatus of claim 1, further comprising a filter in said housing.

4. The apparatus of claim 1, wherein said concentration is reduced to 0.1 ppm or less.

5. The apparatus of claim 1, further comprising at least one sensor for detecting the concentration of ozone at said output of said apparatus.

6. The apparatus of claim 5, further comprising a source of ozone in communication with said ozone chamber and a controller responsive to said sensor for terminating the flow of ozone from said source of ozone when said sensor detects an ozone concentration above a predetermined level.

7. The apparatus of claim 1, further comprising an anemometer for measuring the volume of said fluid at said inlet, and a controller responsive to said anemometer for controlling the amount of ozone in said ozone chamber.

8. Decontamination apparatus for destroying airborne organic contaminants, comprising:
a. an inlet adapted to receive and draw inlet air into said apparatus,
b. an ozone gas introduction system, adapted to infuse ozone gas into said inlet air in said apparatus,
c. a first mixing chamber wherein said ozone gas and said inlet air combine, and
c. a second mixing chamber where the concentration of said ozone in said combined ozone and air is reduced.

9. The apparatus of claim 8, wherein a sufficient and measurable amount of ozone is infused so as to effectively decontaminate said inlet air.

10. The apparatus of claim 9, wherein said sufficient amount is in excess of 100 ppm.

11. The apparatus of claim 8, wherein said ozone and said inlet air remain in said first mixing chamber for a sufficient, and measurable residence time so as to effectively decontaminate said inlet air.

12. The apparatus of claim 8, wherein said concentration of ozone is reduced via a catalyst and/or scrubber, said catalyst capable of reducing ozone into diatomic and atomic oxygen.

13. The apparatus of claim 8, wherein said catalyst reduces concentration of said ozone to below a predetermined level.

14. The apparatus of claim 13, wherein said level is 0.1 ppm.

15. The apparatus of claim 8, further comprising at least one sensor capable of detecting ozone at the output of said apparatus, wherein said ozone injection system is disabled if said at least one sensor measures an ozone level above a predetermined level.

16. The apparatus of claim 8, further comprising means to measure the volume of said inlet air, wherein the amount of said ozone infused is responsive to said measured volume.

17. The apparatus of claim 8, further comprising means for producing sonic or ultrasonic waves, wherein said waves facilitate the separation of said contaminants.

18. The apparatus of claim 17, wherein said sonic or ultrasonic wave producing means is located within said first mixing chamber.

19. The apparatus of claim 8, further comprising air drawing means to direct air into said inlet.

20. The apparatus of claim 8, further comprising a loopback mechanism, said mechanism allowing treated air exiting said second mixing chamber to be directed to said inlet to be further treated.

21. A method for destroying air-borne bacterial, viral, or any other organic contaminant comprising:
a. drawing air into a decontamination apparatus,
b. introducing ozone gas into said inlet air,
c. mixing said ozone and said inlet air , and
c. reducing the concentration of said ozone in said mixed ozone and air.

22. The method of claim 21, wherein said ozone is injected in sufficient quantity to destroy said contaminants.

23. The method of claim 22, wherein said sufficient quantity is in excess of 100 ppm.

24. The method of claim 21, wherein said ozone and said inlet air are mixed for a sufficient time to destroy said contaminants.

25. The method of claim 21, wherein said ozone is reduced by mixing said mixed ozone and air with a catalyst.

26. The method of claim 25, wherein said catalyst reduces said ozone gas to diatomic oxygen and atomic oxygen.

27. The method of claim 25, wherein said catalyst is mixed with said ozone for a sufficient time to reduce concentration of said ozone to below a predetermined level.

28. The method of claim 27, wherein said predetermined level is 0.1 ppm.

29. The method of claim 21, further comprising the steps of monitoring the air at the outlet of said apparatus for its concentration of ozone gas and disabling said injection of ozone if said outlet air contains ozone concentration above a predetermined level.

30. The method of claim 21, further comprising the steps of measuring the volume of said inlet air and injecting a known concentration and flowrate of ozone in response to said measurement.

31. The method of claim 21, further comprising the step of injecting sonic or ultrasonic waves while mixing ozone with said inlet air.

32. The method of claim 21, wherein air which has been decontaminated is directed back into said decontamination apparatus.

33. The method of claim 21, wherein a known and controllable amount of inlet air can be mixed with a known and controllable amount of ozone for a known amount of time which relates to a known destruction efficiency of bio-contaminents.
